(19) United States
(12) Patent Application Publication
(10) Pub. No.: US 2017/0104607 A1
(43) Pub. Date: Apr. 13, 2017

(54) METHODS TO AVOID I2C VOID MESSAGE IN I3C

(71) Applicant: QUALCOMM Incorporated, San Diego, CA (US)

(72) Inventor: Shoichiro Sengoku, San Diego, CA (US)

(21) Appl. No.: 14/882,011

(22) Filed: Oct. 13, 2015

(51) Int. Cl. H04L 12/40; H04L 29/06; H04L 12/403

(52) U.S. Cl. CPC H04L 12/40019; H04L 12/403; H04L 69/18

(57) ABSTRACT

System, methods and apparatus offer improved coexistence of devices on a serial bus. A bus master coupled to a serial bus transmits a start condition on the serial bus, and a first series of pulses on a clock line of the serial bus, the pulses having a duration that is less than a maximum duration for spikes to be filtered in accordance with the I2C protocol. The bus master transmits a second series of pulses on the clock line, the pulses having a duration that is greater than or equal to a minimum duration for clock pulses defined by the I2C protocol, and uses the second series of pulses to transmit a data frame on the serial bus in accordance with a different protocol. A stop condition is transmitted on the serial bus in accordance with the I2C protocol after transmission of the data frame is completed.

### BACKGROUND

Field

The present disclosure relates generally to an interface between processors and peripheral devices and, more particularly, to improving coexistence between devices coupled to a serial bus that communicate using different protocols.

Background

The Inter-Integrated Circuit serial bus, which may also be referred to as the I2C bus or the PC bus, is a serial single-ended computer bus that was intended for use in connecting low-speed peripherals to a processor. The I2C bus is a multi-master bus in which each device can serve as a master and a slave for different messages transmitted on the I2C bus. The I2C bus can transmit data using only two bidirectional open-drain connectors, including a Serial Data Line (SDA) and a Serial Clock Line (SCL). The connectors typically include signal wires that are terminated by pull-up resistors. Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

In some systems and apparatus, mobile communications devices, such as cellular phones, may employ multiple devices, such as cameras, displays and various communications interfaces that consume significant bandwidth. A serial bus in such systems and apparatus may employ a combination of I2C protocols and other protocols (such as the I3C protocol, which is derived from the I2C protocol) that can increase available bandwidth on the serial bus through higher transmitter clock rates, for example. Devices that employ more recent protocols can coexist with I2C devices using various techniques, including the use of signaling that is not recognized or ignored by an I2C device. Certain coexistence issues may remain in these systems when some formats of the more recent protocols appear to legacy devices to be illegal under I2C protocols. Accordingly, there exists an ongoing need for providing improved coexistence between devices connected to a serial interface.

### SUMMARY

Embodiments disclosed herein provide systems, methods and apparatus that provide improved coexistence of devices coupled to a serial bus by eliminating the occurrence of void messages. Void messages include messages transmitted by a first device in accordance with a first protocol that violate a second protocol and are accordingly considered to be illegal transmissions by a second device. In one example, void messages can result when clock pulses in signaling defined by protocols used for high-speed data transmission are not recognized by an I2C receiver.

In an aspect of the disclosure, a method of data communications at a bus master device coupled to a serial bus includes transmitting a start condition on the serial bus in accordance with an I2C protocol, transmitting a first series of pulses on a clock line of the serial bus, the first series of pulses having a duration that is less than a maximum duration for spikes to be filtered in accordance with the I2C protocol, transmitting a second series of pulses on the clock line of the serial bus, the second series of pulses having a duration that is greater than or equal to a minimum duration for clock pulses defined by the I2C protocol, using the second series of pulses to serially transmit a byte of data on a data line of the serial bus, and transmitting a stop condition on the serial bus in accordance with the I2C protocol after transmission of the byte is completed.

In an aspect of the disclosure, a bus master apparatus configured to be coupled to a serial bus includes a transceiver configured to exchange data through a data line of the serial bus, a line driver configured to control signaling state of a clock line of the serial bus, and a transmitter circuit coupled to the transceiver and the line driver. The transmitter circuit may be configured to transmit a start condition on the serial bus in accordance with an I2C protocol, transmit a first series of pulses on the clock line of the serial bus, the first series of pulses having a duration that is less than a maximum duration for spikes to be filtered in accordance with the I2C protocol, transmit a second series of pulses on the clock line of the serial bus, the second series of pulses having a duration that is greater than or equal to a minimum duration for clock pulses defined by the I2C protocol, use the second series of pulses to serially transmit a byte of data on a data line of the serial bus, and transmit a stop condition on the serial bus in accordance with the I2C protocol after transmission of the byte is completed.

In an aspect of the disclosure, an apparatus includes a first integrated circuit device coupled to a serial bus, and a second integrated circuit device coupled to the serial bus. The second integrated circuit device may include a transmitter circuit configured to transmit to the first device using the serial bus, a start condition in accordance with an I2C protocol, transmit to the first device a first series of pulses on a clock line of the serial bus, the first series of pulses having a duration that is less than a maximum duration for spikes to be filtered in accordance with the I2C protocol, transmit a second series of pulses to the first device using the clock line of the serial bus, the second series of pulses having a duration that is greater than or equal to a minimum duration for clock pulses defined by the I2C protocol, use the second series of pulses to serially transmit a byte of data to the first device on a data line of the serial bus, and transmit to the first device using the serial bus, a stop condition in accordance with the I2C protocol after transmission of the byte is completed.

In an aspect of the disclosure, a processor readable storage medium having code stored thereon that is executable by a processor. The code may include instructions that cause the processor to transmit a start condition on the serial bus in accordance with an I2C protocol transmit a first series of pulses on a clock line of the serial bus, each pulse of the first series of pulses having a duration that is less than a maximum duration for spikes to be filtered in accordance with the I2C protocol, transmit a second series of pulses on the clock line of the serial bus, the second series of pulses having a duration that is greater than or equal to a minimum duration for clock pulses defined by the I2C protocol, use the second series of pulses to serially transmit a byte of data on a data line of the serial bus, and transmit a stop condition on the serial bus in accordance with the I2C protocol after transmission of the byte is completed.

### BRIEF DESCRIPTION OF THE DRAWINGS

FIG. 1 depicts an apparatus employing a data link between IC devices that selectively operates according to one of plurality of available standards.

FIG. 2 illustrates a system architecture for an apparatus employing a data link between IC devices.

FIG. 3 illustrates a configuration of slave devices coupled to a common serial bus where the slave devices communicate using different protocols.

FIG. 4 illustrates timing relationships between data and clock signals transmitted on a serial bus that uses multiple communications protocols.

FIG. 5 illustrates the operation of a spike filter employed in certain slave devices.

FIG. 6 illustrates signaling associated with start and stop conditions employed to delineate transmissions on an I2C bus.

FIG. 7 illustrates a timing diagram of an I2C one byte write data operation.

FIG. 8 illustrates signaling associated with repeated start conditions used on an I2C bus.

FIG. 9 illustrates the occurrence of a void message in a serial bus adapted in accordance with certain aspects disclosed herein.

FIG. 10 illustrates the occurrence of a void message in the context of an I3C transmission perceived by an I2C slave device adapted in accordance with certain aspects disclosed herein.

FIG. 11 illustrates a one example of a transmission that may be used to avoid the occurrence of void message detection at an I2C slave device in accordance with certain aspects disclosed herein.

FIG. 12 illustrates the example of FIG. 11 in the context of an I3C transmission perceived by an I2C slave device adapted in accordance with certain aspects disclosed herein.

FIG. 13 illustrates additional examples of transmissions that may be used to avoid the occurrence of void message detection at an I2C slave device in accordance with certain aspects disclosed herein.

FIG. 14 illustrates an example of a transmission that includes a repeated start condition configured to avoid the occurrence of void message detection at an I2C slave device in accordance with certain aspects disclosed herein.

FIG. 15 is a block diagram illustrating an example of an apparatus employing a processing system that may be adapted according to certain aspects disclosed herein.

FIG. 16 is a flow chart of method of data communications at a bus master device coupled to a serial bus according to one or more aspects disclosed herein.

FIG. 17 is a diagram illustrating an example of a hardware implementation for a transmitting apparatus that communicates over a serial bus in accordance with one or more aspects disclosed herein.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments. Various aspects are now described with reference to the drawings. In the following description, for purposes of explanation, numerous specific details are set forth in order to provide a thorough understanding of one or more aspects. It may be evident, however, that such aspects may be practiced without these specific details.

### Overview

According to certain aspects disclosed herein a data transfer interface operating in accordance with a first protocol may be adapted to introduce benign bytes within a high-speed communication transaction in order to avoid the detection of a void message by a second device that communicates in accordance with a second, lower-speed protocol. Void messages include messages that violate protocols defined for the second protocol and are accordingly considered to be illegal transmissions by the second device. The first device and the second device may be coupled to a serial bus. In one example, the higher-speed protocol is used by an I3C device and the lower-speed protocol is used by an I2C slave device.

### Example of a Device Employing a Serial Bus

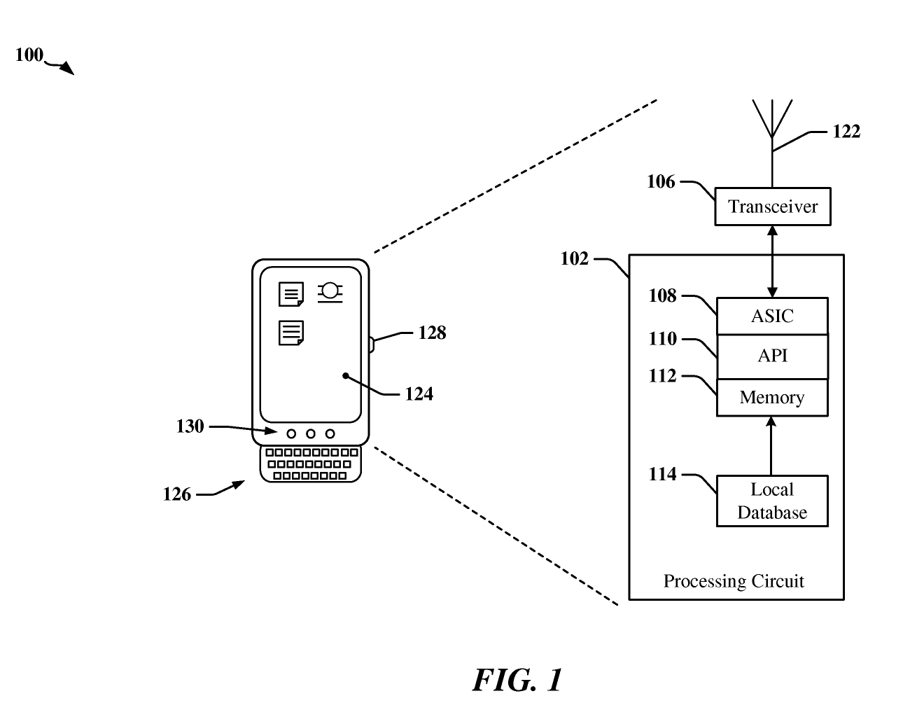

FIG. 1 depicts one example of an apparatus 100 that may be adapted according to certain aspects disclosed herein. In one example, the apparatus 100 may include a wireless communication device that communicates through an RF transceiver with a radio access network (RAN), a core access network, the Internet and/or another network. The apparatus 100 may include a communications transceiver 106 operably coupled to a processing circuit 102. The processing circuit 102 may include one or more IC devices, such as an application-specific IC (ASIC) 108. The ASIC 108 may include one or more processing devices, logic circuits, and so on. The processing circuit 102 may include and/or be coupled to processor readable storage such as a memory device 112 that may maintain instructions and data that may be executed by the processing circuit 102. The processing circuit 102 may be controlled by one or more of an operating system and an application programming interface (API) 110 layer that supports and enables execution of software modules residing in storage media, such as the memory device 112 of the wireless device. The memory device 112 may include read-only memory (ROM) or random-access memory (RAM), electrically erasable programmable ROM (EEPROM), flash cards, or any memory device that can be used in processing systems and computing platforms. The processing circuit 102 may include or access a local database 114 that can maintain operational parameters and other information used to configure and operate the apparatus 100. The local database 114 may be implemented using one or more of a database module, flash memory, magnetic media, EEPROM, optical media, tape, soft or hard disk, or the like. The processing circuit may also be operably coupled to external devices such as an antenna 122, a display 124, operator controls, such as button 128 and keypad 126 among other components.

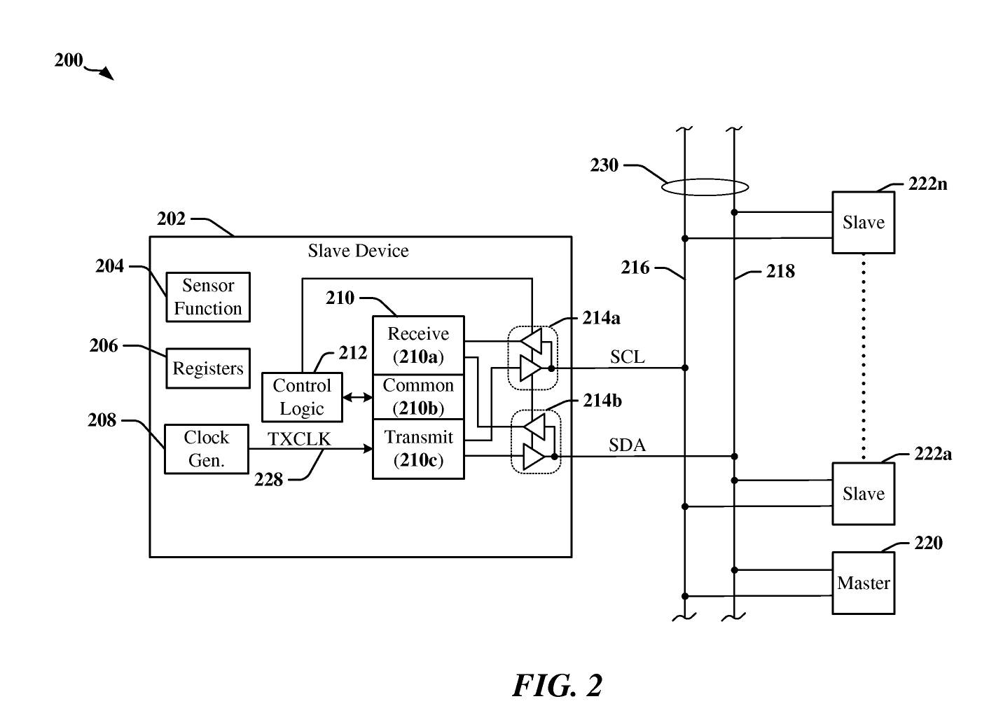

FIG. 2 is a block schematic drawing illustrating certain aspects of an apparatus 200 that includes multiple devices 202, 220 and 222a-222n connected to a communications bus 230. The devices 202, 220 and 222a-222n may include one or more semiconductor integrated circuit (IC) devices, such as an applications processor or an ASIC. The devices 202, 220 and 222a-222n may include a modem, a signal processing device, a display driver, a camera, a user interface, a sensor, a sensor controller, a media player, a radio frequency (RF) transceiver, and/or other such components or devices. The apparatus 200 may be embodied in a mobile wireless device.

In one example, the apparatus 200 includes multiple devices 202, 220 and 222a-222n that communicate using an I2C bus 230 and at least one imaging device 202 may be configured to operate as a slave device on the I2C bus 230. The imaging device 202 may be adapted to provide a sensor control function 204. In one example, the sensor control function 204 may include circuits and modules that support an image sensor. In other examples, the sensor control function 204 may control and/or communicate with one or more sensors that measure environmental conditions. In addition, the imaging device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided by a clock generation circuit 208.

Two or more of the devices 202, 220 and/or 222a-222n may be adapted according to certain aspects and features disclosed herein to support a plurality of different communication protocols over a common bus, which may include the Inter-Integrated Circuit (I2C) protocol, and/or the I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the 2-wire bus 230, and/or alternating current (AC) characteristics affecting certain timing aspects of signals transmitted on the 2-wire bus 230.

### Coexistence of Devices Coupled to a Serial Bus

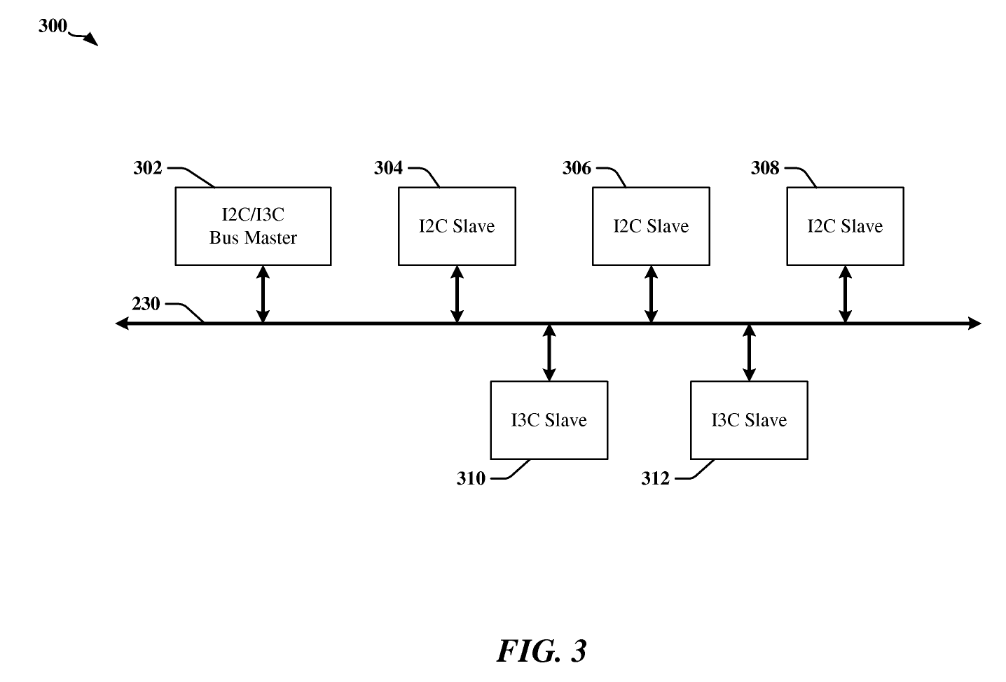

FIG. 3 illustrates a configuration of devices 302, 304, 306, 308, 310, and 312 connected to a 2-wire bus 230 that may support a plurality of communication protocols. Devices 302, 304, 306, 308, 310, and 312 may communicate using the 2-wire bus 230 by exchanging data on the SDA 218 (see FIG. 2) when a clock signal is transmitted on the SCL 216. In the illustrated example, three slave devices 304, 306 and 308 are limited to communicating using I2C protocols over the 2-wire bus 230, while two slave devices 310 and 312 are adapted or configured to communicate using I3C protocols over the 2-wire bus 230. A single bus master device 302 may operate as a bus master in both I2C and I3C modes of operation.

The I3C-capable slave devices 302, 310 and 312 may coexist with the I2C-limited slave devices 304, 306 and 308 using I2C protocols. While multiple bus masters may be employed in I3C modes of operation, I2C protocols provide for a single bus master. In the example, a single bus master 302 can communicate in an I2C mode of operation and in an I3C mode of operation. One or more of the I3C-capable slave devices 310, 312 may also communicate using I2C protocols. For example, the bus master 302 may communicate with one of the I3C-capable slave devices 310 or 312 using I3C protocols to transfer high-volume or high-speed data, and may communicate low-volume information to the same I3C-capable slave device 310 or 312 using I2C protocols. In some instances, certain control and configuration information using I2C protocols as a common method to broadcast messages to multiple slave devices 302, 304, 306, 308, 310, and 312.

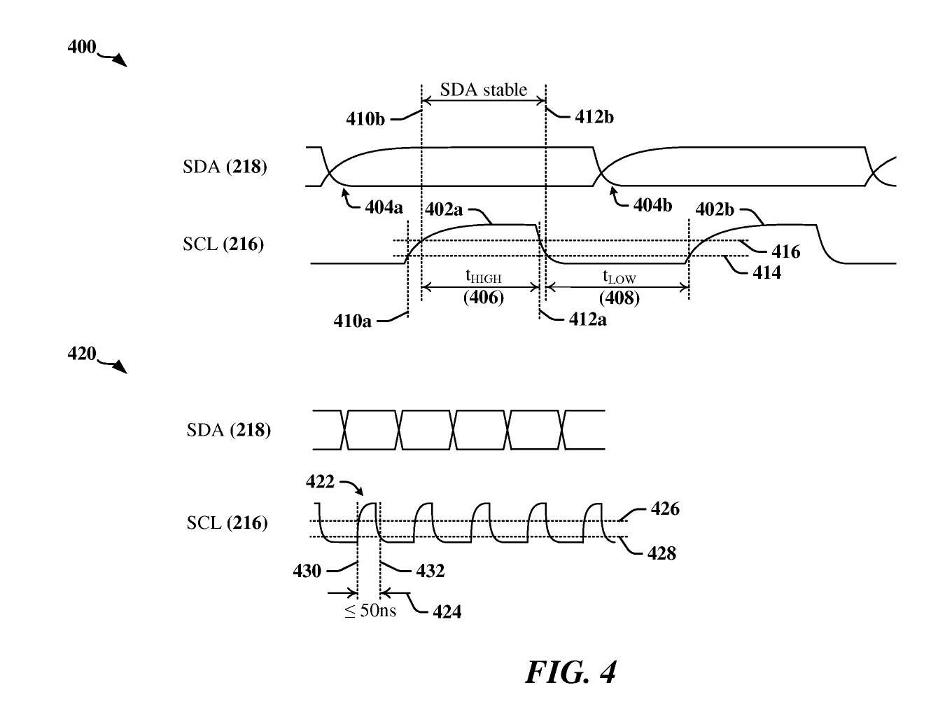

FIG. 4 provides timing diagrams 400, 420 illustrating the relationship between signals transmitted on the SDA 218 and the SCL 216. The first timing diagram 400 illustrates timing consistent with I2C protocols, and relates to the timing relationship between the SDA 218 and the SCL 216 while data is being transferred on the 2-wire bus 230. The SCL 216 provides a series of clocking pulses 402a, 402b that can be used to sample a data signal transmitted on the SDA 218. When the SCL 216 is in a logic high state during data transmission, data on the SDA 218 is required to be stable and valid, such that the state of the SDA 218 is not permitted to change when the SCL 216 is in a high state. In a logic low state, receiving circuits ignore (or do not care about) the state of the SDA 218.

Specifications for the I2C protocol (herein referred to as “I2C Specifications”) define a minimum duration for the high period (t_{HIGH}) 406 of each pulse 402a, 402b on the SCL 216. The high period 406 of the pulse 402a, 402b corresponds to the time in which the SCL 216 has a voltage greater than a threshold minimum voltage level 416 for the high logic state. The I2C Specifications also define minimum durations for a setup time and a hold time associated with transitions in the pulse 402a, 402b, and during which the signaling state of the SDA 218 must remain in the high logic state. The setup time defines a maximum time period after a transition 404a between signaling states on the SDA 218 until the arrival of the rising edge of a pulse 402a, 402b on the SCL 216. The hold time defines a minimum time period after the falling edge of the pulse 402a, 402b on the SCL 216 until a next transition 404b between signaling states on the SDA 218. The I2C Specifications also define a minimum duration for a low period (t_{LOW}) 408 for the SCL 216, when the voltage of the SCL 216 is below a threshold maximum value 414 for the low logic state. The data on the SDA 218 is typically captured in the high period 406, when the SCL 216 is in the high logic state after the leading edge of the pulse 402a, 402b.

The second timing diagram 420 illustrates timing consistent with I3C protocols, and relates to the timing relationship between the SDA 218 and the SCL 216 while data is being transferred on the 2-wire bus 230 at higher data rates (e.g. 6-16 Mbps) than data rates typically available using I2C protocols (e.g., 0.1-3.2 Mbps). In the I3C example, a clock signal transmitted on the SCL 216 includes a series of pulses, as illustrated by the pulse 422, that can be used to sample a data signal transmitted on the SDA 218. Each pulse 422 transmitted on the SCL 216 during I3C modes of operation may have a pulse width 424 that is 50 ns or less. Coexistence of slave devices 304, 306, 308, 310, and 312 can be accomplished when the I2C-limited slave devices 304, 306 and 308 comply with I2C protocols and ignore pulses 422 transmitted during I3C transactions on the 2-wire bus 230 with a duration of 50 ns or less.

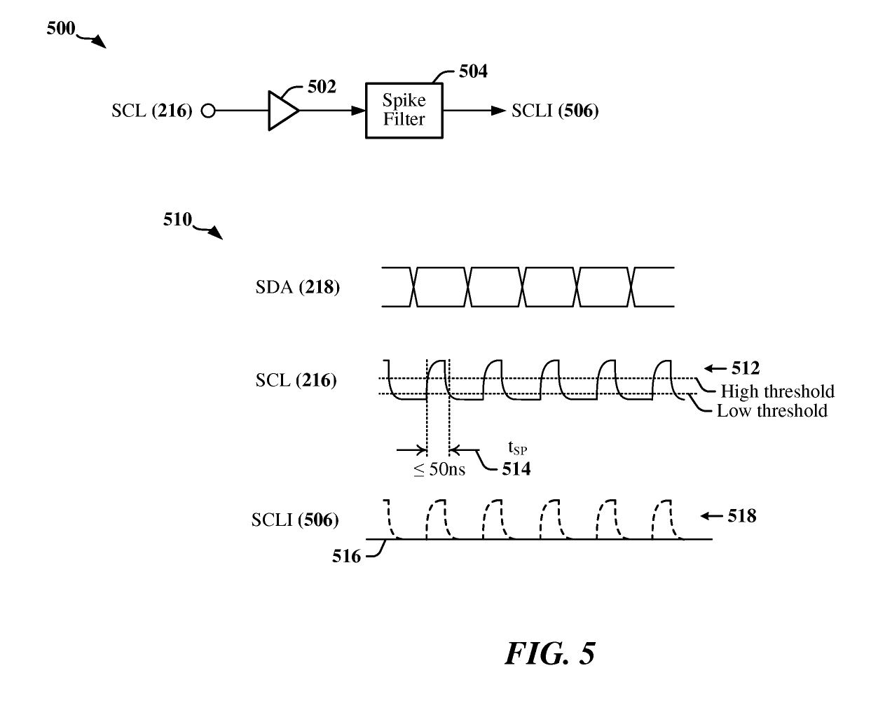

FIG. 5 is a diagram that illustrates the operation of I2C-limited slave devices 304, 306 and 308 during I3C modes of operation. In accordance with I2C protocols, an input circuit 500 of an I2C-limited slave device 304, 306, 308 includes a spike filter 504 that filters signals received from the SCL 216 by a line receiver 502. The spike filter 504 produces a filtered serial clock signal (SCLI) 506 that is used by the I2C-limited slave device 304, 306, 308 to sample the signal transmitted on the SDA 218. The spike filter 504 may be adapted or configured to filter any pulses on the SCL 216 that have a duration 514 (t_{SP}) of 50 ns or less.

The timing diagrams 510 in FIG. 5 illustrate timing of signals on the SCL 216, SDA 218, and SCLI 506 when the 2-wire bus 230 is operated in accordance with an I3C mode of operation. In I3C modes of operation, the pulses 512 on the SCL 216 have a duration 514 of 50 ns or less and are filtered by the spike filters 504 of I2C-limited slave devices 304, 306, 308. The SCLI 506 output by the spike filters 504 may remain at a low logic level 516 (e.g., 0 Volts) for the duration of data transfers in the 13C mode of operation. In the timing diagrams 510, occurrences of the pulses 512 received from the SCL 216 that are filtered by the spike filter 504 are shown as broken line pulses 518 in the SCLI 506.

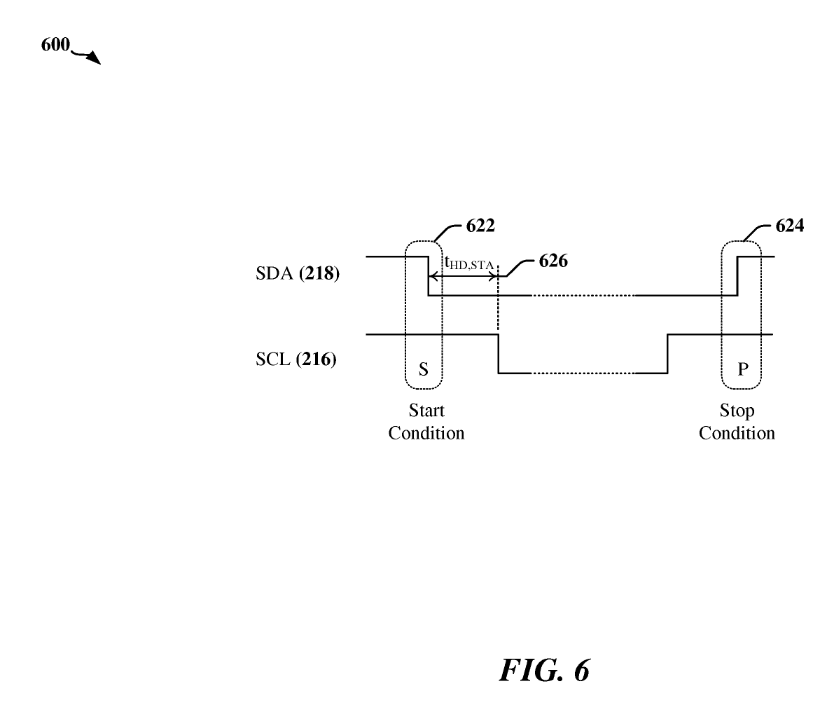

FIG. 6 is a timing diagram 600 that illustrates timing of signaling states on the SDA 218 and the SCL 216 used to initiate and terminate transmissions on the 2-wire bus 230. Start conditions 622 and stop conditions 624 are recognized in I2C and I3C modes of operation. A start condition 622 is used by the bus master 302 to signal that data is to be transmitted. The start condition 622 occurs when the SDA 218 transitions from high to low while the SCL 216 is high. In I2C modes of operation, the bus master 302 transmits the start condition 622. The master device 302 then transmits a clock signal on the SCL 216 and data is exchanged over the SDA 218. Transmission is completed when a stop condition 624 is transmitted by the master device 302. The stop condition 624 occurs when the SDA 218 transitions from low to high while the SCL 216 is high. The I2C Specifications require that all transitions of the SDA 218 occur when the SCL 216 is low, and exceptions may be treated as a start condition 622 or a stop condition 624.

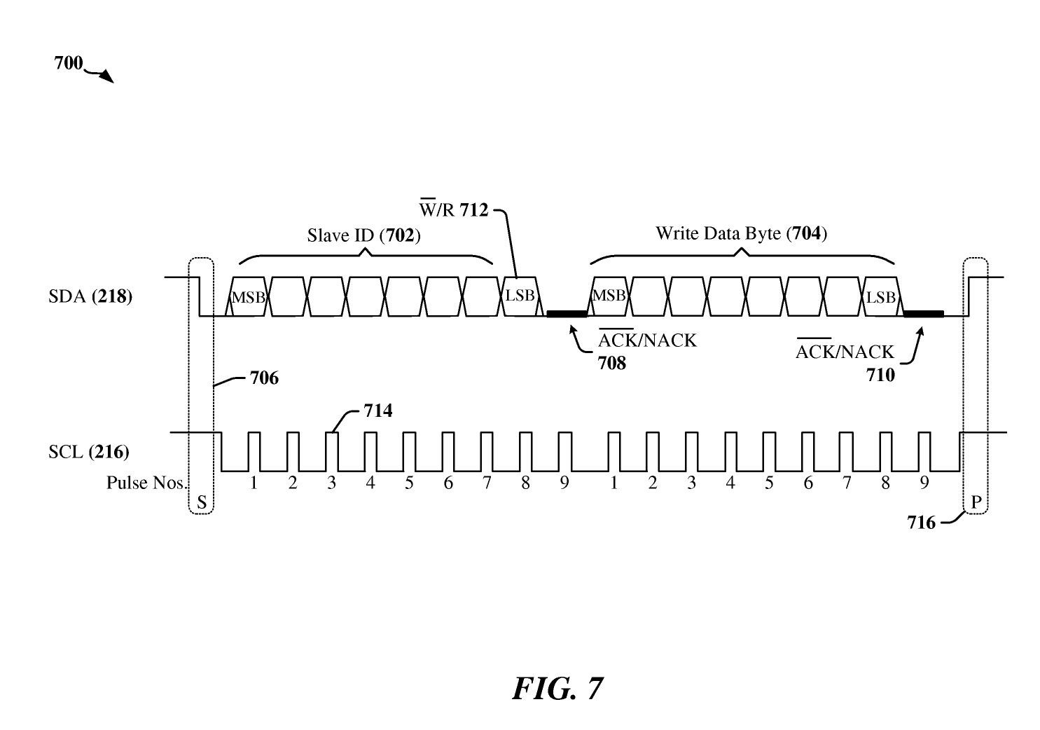

FIG. 7 is a timing diagram 700 illustrating an I2C one byte write data operation. The write operation commences after the start condition 706, and is terminated by the stop condition 716. An I2C master node sends a 7-bit slave address, which may be referred to as a slave identifier (Slave ID 702) on the SDA 218. The Slave ID 702 indicates which slave node on the I2C bus the master node wishes to access. The Slave ID 702 is followed by a Read/Write bit 712 that indicates whether the operation is a read or a write operation. In this example, the Read/Write bit 712 is at logic 0 to indicate a write operation; for a read operation the Read/Write bit 712 is at logic 1. Only the slave node that has an address that matches the Slave ID 702 can respond to the write (or read) operation. In order for an I2C slave node to detect its own Slave ID 702, the master node transmits at least 8 bits on the SDA 218, together with 8 clock pulses transmitted on the SCL 216. The I2C protocol provides for transmission of 8-bit data (bytes) 704 and 7-bit slave addresses 702. Data transmissions are acknowledged when the receiver drives the SDA 218 for one clock period 708, and a low signaling state represents an acknowledgement (ACK) indicating successful reception, while a high signaling state represents a negative acknowledgement (NACK) indicating a failure to receive, or occurrence of an error during reception.

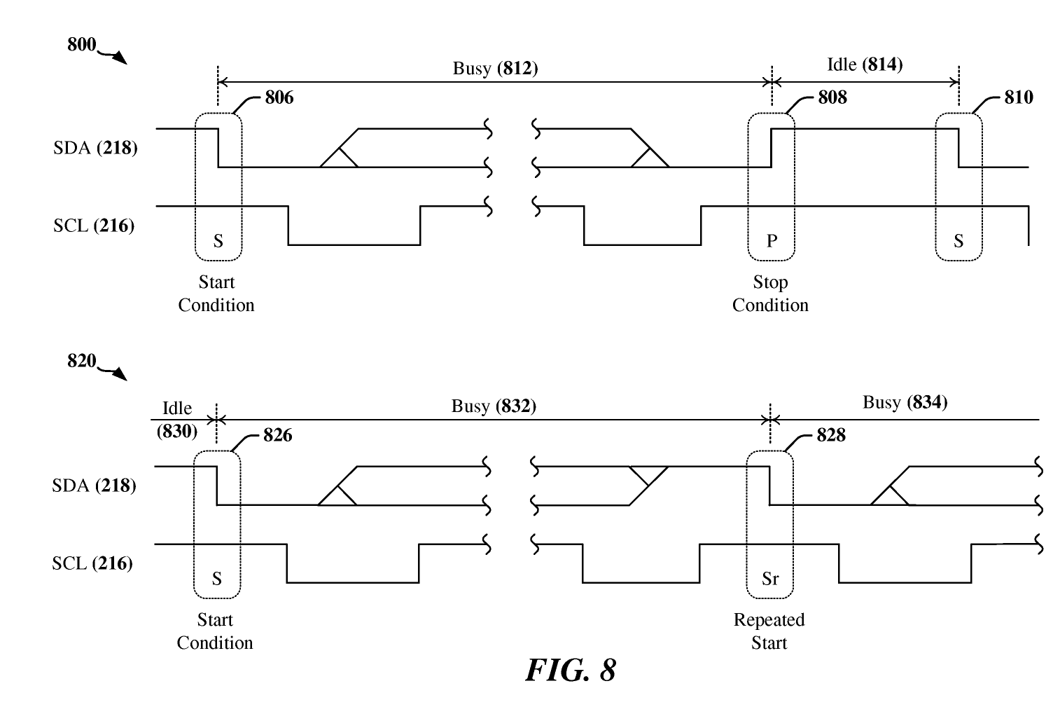

FIG. 8 includes timing diagrams 800 and 820 that illustrate timing associated with multiple frame transmissions on the 2-wire bus 230. A frame may include one or more bytes of data transmitted between a start condition 806 and stop condition 808. The 2-wire bus 230 may be considered to be busy in the interval between the start condition 806 and the stop condition 808. The 2-wire bus 230 may be considered to be idle after a stop condition 808 is transmitted and before the next the start condition 806. In some instances, the duration of the idle period 814 between a stop condition 808 and a consecutive start condition 810 may be prolonged, causing decreased data throughput. In operation, a busy period 812 commences when the bus master 302 transmits a first start condition 806, followed by data. The busy period 812 ends when the bus master 302 transmits a stop condition 808 and an idle period 814 ensues. The idle period 814 ends with transmission of a second start condition 810.

With reference also to the timing diagram 820, in some instances, the idle periods 814 between successive frame transmissions on the 2-wire bus 230 may be reduced in number and/or eliminated in some circumstances by transmitting a repeated start condition (Sr) 828 rather than a stop condition. The repeated start condition 828 terminates the preceding frame transmission and simultaneously indicates the commencement of a next frame transmission. The state transition on the SDA 218 is identical for a start condition 826 occurring after an idle period 830 and the repeated start condition 828. That is, the SDA 218 transitions from high to low while the SCL 216 is high. When a repeated start condition 828 is used between frame transmissions, a first busy period 832 is immediately followed by a second busy period 834.

### Void Messages

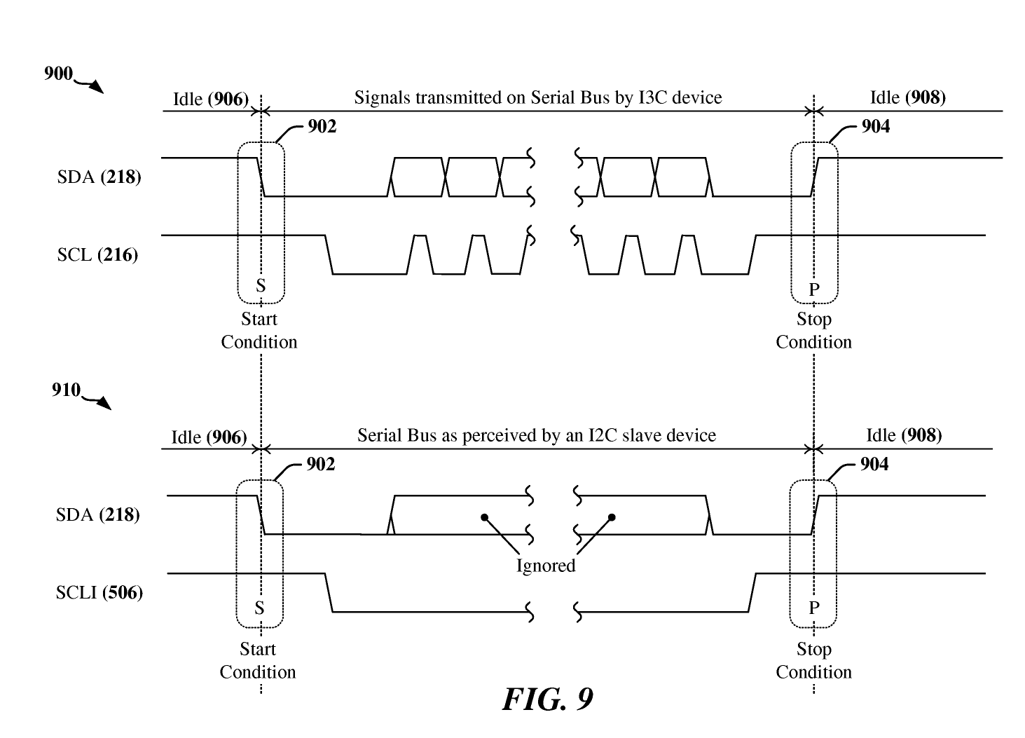

FIG. 9 includes timing diagrams 900, 910 related to signaling states on the SDA 218 and the SCL 216 when the 2-wire bus 230 is operated in accordance with an I3C mode of operation. With reference to the first timing diagram 900, data is transmitted at higher data rates in the I3C mode of operation than in I2C modes of operation, and the clock signal transmitted on the SCL 216 includes pulses that have a duration of 50 ns or less (see FIG. 4). An I3C-capable slave device 302, 310, 312 may sample the SDA 218 using the clock signal on the SCL 216. The second timing diagram 910 illustrates the 2-wire bus 230 as perceived by an I2C-limited slave device 304, 306, 308 that employs a spike filter 504 (see FIG. 5) to remove pulses of 50 ns or less from the SCL 216. The I2C-limited slave device 304, 306, 308 uses a modified clock signal (SCLI 506) output by the spike filter 504 to sample the SDA 218. Pulses in I3C clock signals are effectively suppressed in SCLI 506 except for start conditions 902 and stop conditions 904, since the I3C clock signal includes pulses that have a duration of 50 ns or less. According to I2C protocols, the state of the SDA 218 is to be considered to be “don't care” when the SCL 216 is low. Accordingly, data transmissions in the signal received from the SDA 218 by the I2C-limited slave device 304, 306, 308 are ignored during I3C modes of operation when the SCLI 506 remains in logic low state due to the spike filter 504 suppressing the 50 ns or less I3C clock pulses on SCL 216.

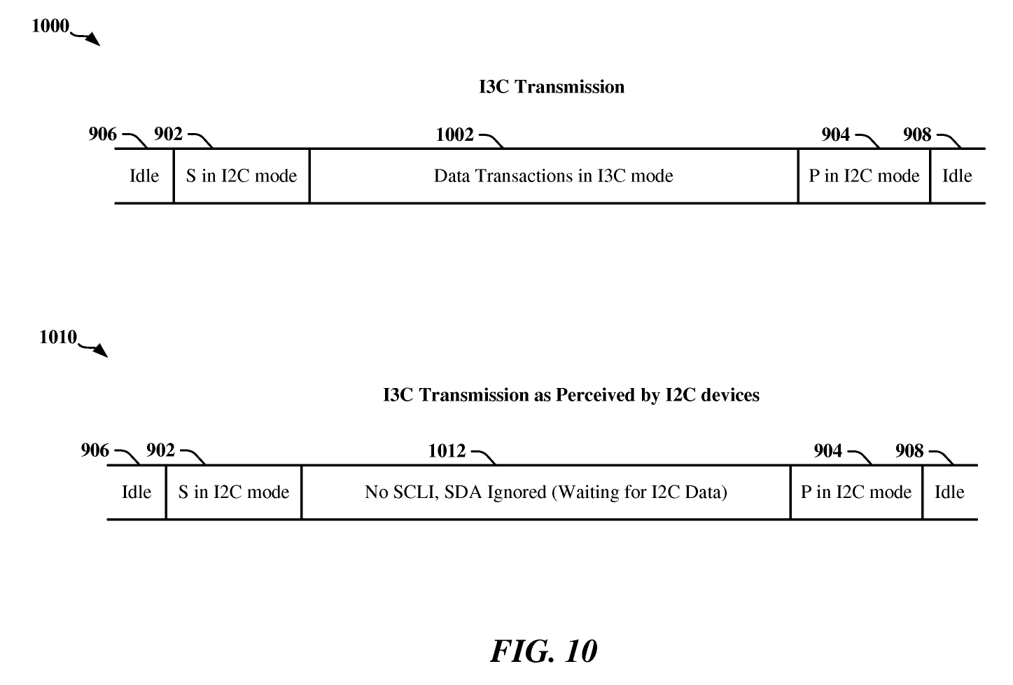

The example illustrated in FIG. 9 is further illustrated in FIG. 10. The example relates to an I3C transmission 1000 by an I3C-capable slave device 302, 310, 312. The I3C transmission 1000 may begin after the first idle period 906 when the start condition 902 is transmitted on the 2-wire bus 230. The start condition 902 is transmitted in accordance with I2C protocols and is recognizable by I2C-limited slave devices 304, 306, 308 and I3C-capable slave devices 302, 310, 312. Two or more I3C-capable slave devices 302, 310, 312 may exchange data in one or more transactions 1002 using a clock signal that includes pulses having a duration of 50 ns or less. After completing the one or more transactions, a stop condition 904 is transmitted on the 2-wire bus 230. The stop condition 904 is transmitted in accordance with I2C protocols and is recognizable by I2C-limited slave devices 304, 306, 308 and I3C-capable slave devices 302, 310, 312. The stop condition 904 causes the 2-wire bus 230 to enter the second idle period 908.

The I3C transmission 1000 is perceived by I2C-limited slave devices 304, 306, 308 as a modified transmission 1010 due to the operation of the spike filters 504, for example. The modified transmission 1010 may begin after a first idle period 906 when the start condition 902 is detected on the 2-wire bus 230. The start condition 902 passes through the spike filter 504, and complies with I2C protocols such that it is recognizable by the I2C-limited slave devices 304, 306, 308. The I2C-limited slave devices 304, 306, 308 may enter a listening mode during a second apparently idle period 1012, during which the slave devices 304, 306, 308 may monitor the 2-wire bus 230 for a clock signal and corresponding address and data transmissions. No data address and data transmissions can be detected when the spike filter suppresses the I3C-mode clock pulses received from the SCL 216 that have a duration of 50 ns or less. The I2C-limited slave devices 304, 306, 308 detect a stop condition 904 before receiving any addresses or data from the 2-wire bus 230. The stop condition 904 is transmitted in accordance with I2C protocols and is recognizable by the I2C-limited slave devices 304, 306, 308. The stop condition 904 causes the 2-wire bus 230 to enter the idle period 908.

The modified transmission 1010 is considered to be a void message, which is identified as an illegal format by I2C protocols. The void message may be defined as a start condition 902 that is immediately followed by a stop condition 904. Indeterminate behavior may result when an I2C-limited slave device 304, 306, 308 receives a void message. In some implementations, the I2C-limited slave device 304, 306, 308 may continue to operate properly after receiving a void message. In other implementations, the void message may cause an I2C-limited slave device 304, 306, 308 to enter an error recovery procedure or behave in a manner that is not specified or prohibited by I2C protocols.

### Techniques for Avoiding Void Messages

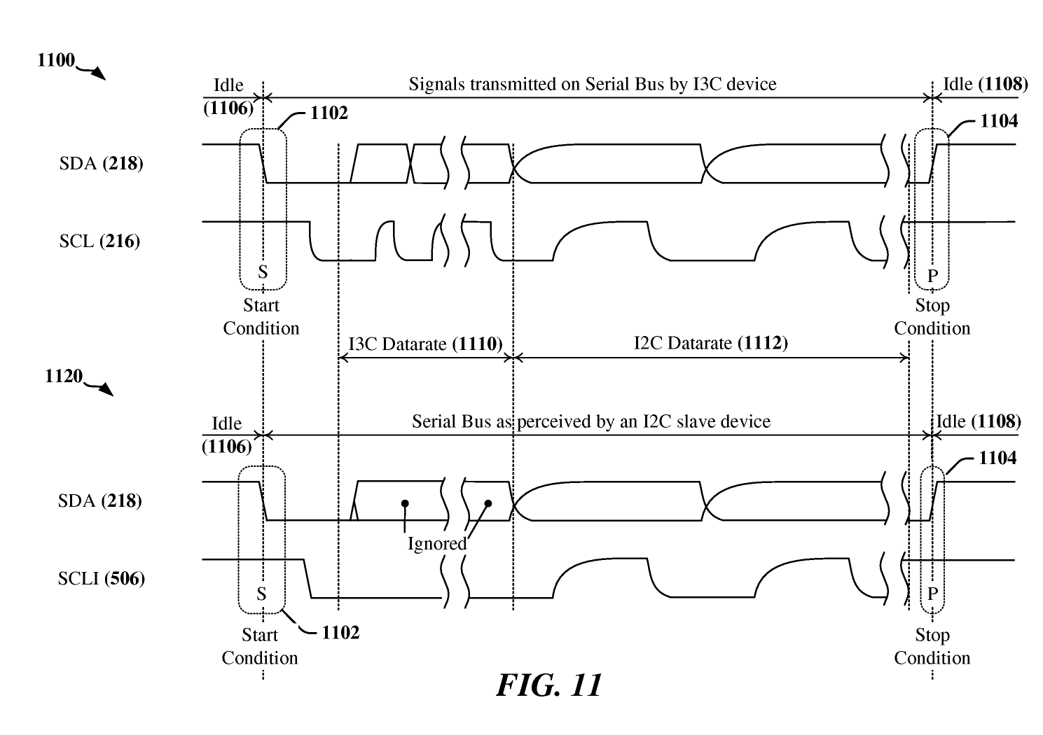

According to certain aspects, void messages may be avoided when a data word is transmitted in accordance with I2C protocols during an I3C transmission. FIG. 11 includes timing diagrams related to certain I3C transmissions 1100, 1120 that illustrate signaling states on the SDA 218 and the SCL 216 when the 2-wire bus 230 is operated in accordance with a modified I3C mode of operation. With reference to the first transmission 1100, a first portion 1110 of the transmission complies or is compatible with I3C protocols and the clock signal transmitted on the SCL 216 includes pulses that have a duration of 50 ns or less. At some point in the transmission, a second portion 1112 of the transmission occurs, using I2C data rates and a clock signal transmitted on the SCL 216 that includes pulses of a duration that is greater than 50 ns. In the second portion 1112, one or more benign bytes are transmitted that are consistent with I2C protocols, such that receipt of a benign byte by I2C-limited slave devices 304, 306, 308 does not result in an error condition. In one example, the benign byte may have a value that is interpreted by the I2C-limited slave devices 304, 306, 308 as slave address, which may relate to a slave device that is not present on the 2-wire serial bus 230.

The second timing diagram 1120 illustrates the 2-wire bus 230 as perceived by an I2C-limited slave device 304, 306, 308 that employs a spike filter 504 (see FIG. 5) to remove pulses of 50 ns or less from the SCL 216. The I2C-limited slave device 304, 306, 308 uses a modified clock signal (SCLI 506) output by the spike filter 504 to sample the SDA 218. I3C clocks signals are effectively suppressed in SCLI 506 except for start conditions 902, stop conditions 904, and any benign bytes transmitted at an I2C data rate. Accordingly, data transmissions in the signal received from the SDA 218 by the I2C-limited slave device 304, 306, 308 are ignored during the first portion 1110 of the transmission, and the I2C-limited slave device 304, 306, 308 may sample the signal received from the SDA 218 during the second portion 1112 of the transmission during which data rates are consistent with I2C protocols. The reception of the benign byte by an I2C-limited slave device 304, 306, 308 can prevent the occurrence or identification of a void message.

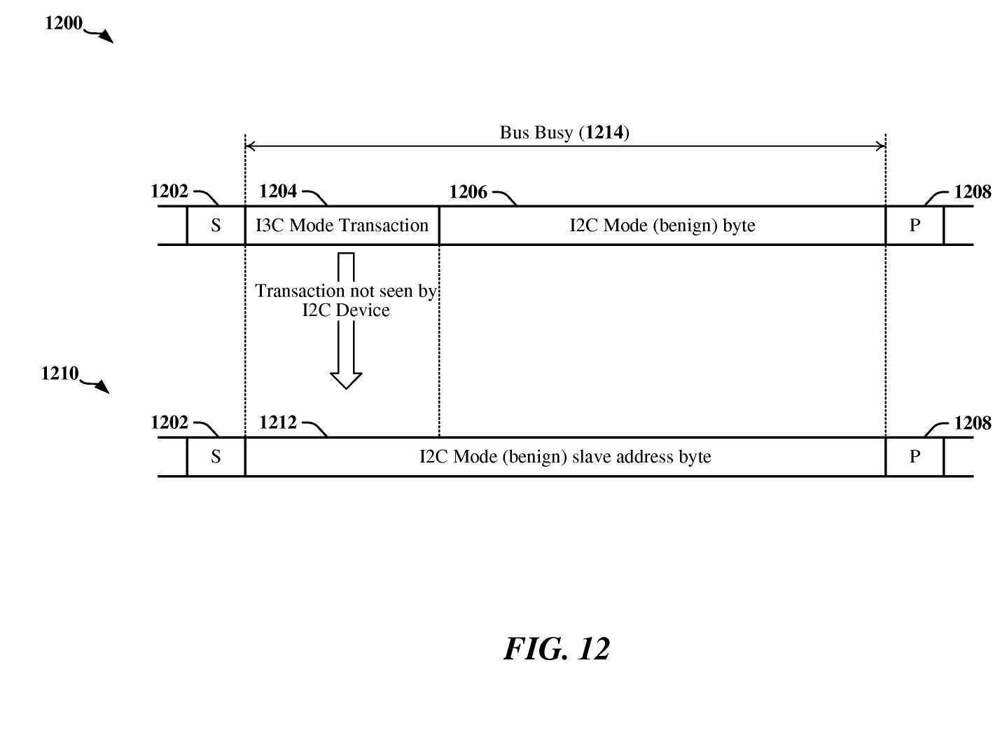

The example illustrated in FIG. 11 is further illustrated in FIG. 12. The transmissions 1200 and 1210 in FIG. 12 relate to one example in which the occurrence of void message detection at I2C-limited slave device 304, 306, 308 may be avoided. The first transmission 1200 corresponds to the I3C transmission 1100 illustrated in FIG. 11. The I3C transmission 1200 may be perceived by I2C-limited slave devices 304, 306, 308 as a modified transmission 1210. From the perspective of an I3C-capable slave device 302, 310, 312, the I3C transmission 1200 begins after a first start condition 1202 is transmitted on the 2-wire bus 230. The start condition 1202 is transmitted in accordance with I2C protocols and is recognizable by I2C-limited slave devices 304, 306, 308 and I3C-capable slave devices 302, 310, 312. Two or more I3C-capable slave devices 302, 310, 312 may exchange data in one or more transactions 1204 using a clock signal that includes pulses having a duration of 50 ns or less. During the busy period 1214 between start condition 1202 and the stop condition 1208, a benign byte 1206 may be transmitted in accordance with I2C protocols.

The combination of the start condition 1202, benign byte 1206 and stop condition 1208 is recognized by I2C-limited slave devices 304, 306, 308 as a valid I2C transmission. The I3C transmission 1200 is perceived by I2C-limited slave devices 304, 306, 308 as the modified transmission 1210, due to the operation of the spike filters 504, for example. The modified transmission 1210 may begin when the start condition 1202 is detected on the 2-wire bus 230. The start condition 1202 conforms or complies with I2C protocols and is recognizable by the I2C-limited slave devices 304, 306, 308. The I2C-limited slave devices 304, 306, 308 may enter a receiving period 1212 that results in the receipt of a benign byte. The receiving period 1212 includes a time interval corresponding to the transmission of the I3C transactions 1204 on the 2-wire serial bus 230. The I2C-limited slave devices 304, 306, 308 may receive the benign byte when pulses received from the SCL 216 comply with timing requirements for an I2C protocol. The I2C-limited slave devices 304, 306, 308 detect the stop condition 1208 after receiving the benign byte 1206 from the 2-wire bus 230 during the receiving period 1212. The stop condition 1208 is transmitted in accordance with I2C protocols and is recognizable by the I2C-limited slave devices 304, 306, 308. The use of a benign byte 1206 can prevent the occurrence of a void message by I2C-limited slave devices 304, 306, 308 during I3C modes of operation.

In the example illustrated in FIG. 12, the benign byte 1206 is transmitted after completing the one or more I3C transactions 1204, and the benign byte 1206 is followed by a stop condition 1208 that is transmitted on the 2-wire bus 230 in accordance with I2C protocols. In other examples, the benign byte 1206 may be transmitted at other times during the busy period 1214 such that the I2C-limited slave device 304, 306, 308 coupled to the 2-wire bus 230 see at least one legal byte transmitted in accordance with an I2C protocol.

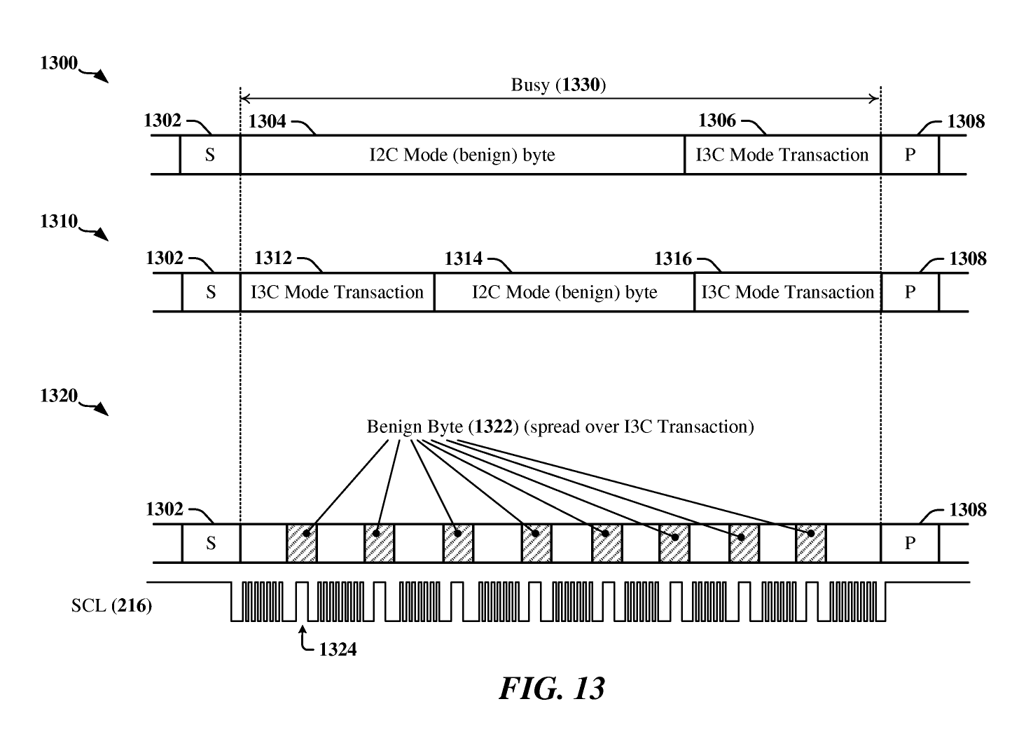

FIG. 13 illustrates examples of other transmissions 1300, 1310, 1320 in which a benign byte 1304, 1314, 1322 is transmitted during a busy period 1330. In a first example, the benign byte 1304 is transmitted as the first byte after the start condition 1302 and before one or more I3C transactions 1306. The benign byte 1304 is transmitted in accordance with an I2C protocol and clock rate. In some instances, the first byte may be a slave address. In a second example, the benign byte 1314 is transmitted between two or more I3C transactions 1312, 1316, frames and or data bytes. The benign byte 1314 is transmitted in accordance with an I2C protocol and clock rate. In a third example, the bits of a benign byte 1322 are interleaved or interspersed between data transmitted in accordance with I3C protocols. The bits of the benign byte 1322 may be spread at regular time intervals, at random and/or separated by a predefined number of I3C clock pulses transmitted on the SCL 216. A clock signal transmitted on the SCL 216 may include individual clock pulses 1324 transmitted in accordance with I2C protocols and interleaved with I3C clock pulses to enable an I2C device to capture the bits of the benign byte 1322. In a fourth example, a clock signal transmitted on the SCL 216 in an I3C mode of communication involving a bus master 302 and an I3C-capable slave device 302, 310, 312 may include a number of elongated clock pulses 1324 that have a pulse duration consistent with I2C protocols, such that bits of an I3C frame corresponding to the elongated clock pulses 1324 are received by I2C-limited slave devices 304, 306, 308 and interpreted as bits of a benign byte 1322 by the I2C-limited slave devices 304, 306, 308.

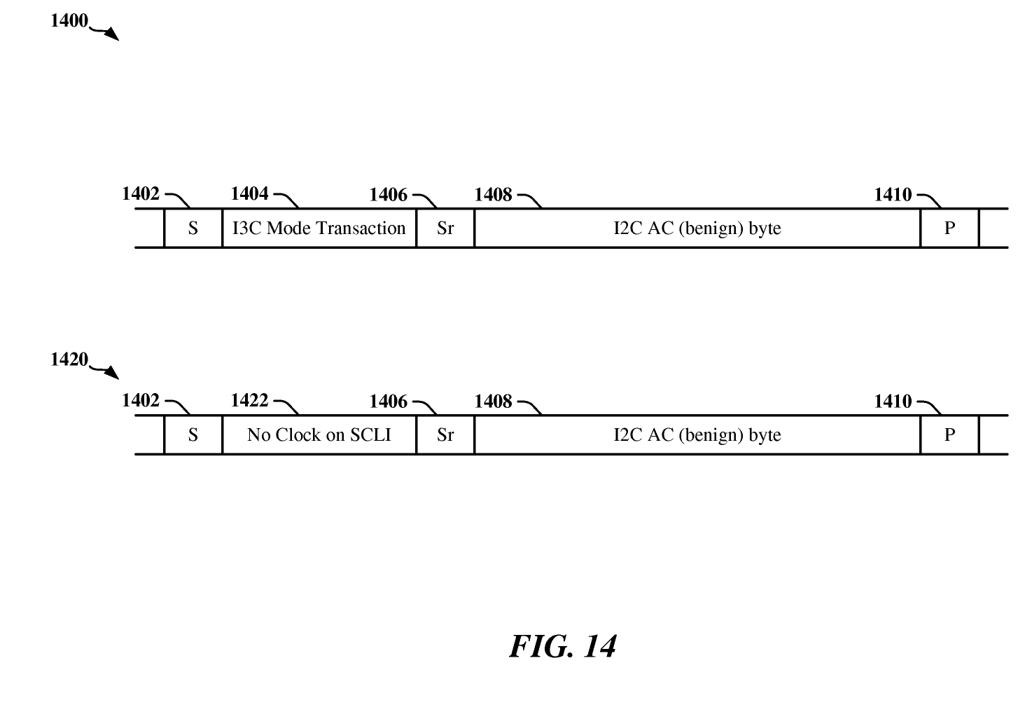

FIG. 14 includes examples of transmissions 1400 and 1420 that illustrate the use of a repeated start condition 1406 to separate I3C transactions 1404 from a benign byte 1408 transmitted on the 2-wire bus 230. The transmission 1400 begins after a first start condition 1402 is transmitted on the 2-wire bus 230. The start condition 1402 is transmitted in accordance with I2C protocols and is recognizable by I2C-limited slave devices 304, 306, 308 and I3C-capable slave devices 302, 310, 312. Two or more I3C-capable slave devices 302, 310, 312 may exchange data in one or more transactions 1404 using a clock signal that includes pulses having a duration of 50 ns or less. After completing the one or more transactions 1404, a repeated start condition 1406 may be transmitted on the 2-wire bus 230. After the repeated start condition 1406 is transmitted, the benign byte 1408 may be transmitted in accordance with I2C protocols. A stop condition 1410 is transmitted on the 2-wire bus 230 in accordance with I2C protocols after the benign byte 1408.

The combination of the start condition 1402, the repeated start condition 1406, benign byte 1408 and the stop condition 1410 is recognized by I2C-limited slave devices 304, 306, 308 as a valid I2C transmission sequence. The I3C transmission 1400 is perceived by I2C-limited slave devices 304, 306, 308 as the modified transmission 1420, due to the operation of the spike filters 504. The modified transmission 1420 may begin when the start condition 1402 is detected on the 2-wire bus 230. The start condition 1402 conforms or complies with I2C protocols and is recognizable by the I2C-limited slave devices 304, 306, 308. The I2C-limited slave devices 304, 306, 308 may enter a receiving period 1422 corresponding to the transmission of the I3C transactions 1404 on the 2-wire serial bus 230. The receiving period 1422 is terminated by the repeated start condition 1406. I2C protocols require that slave devices reset their bus logic when a start condition 1402 or repeated start condition 1406 is received, such that the slave devices anticipate receiving a slave address after the start condition 1402 or repeated start condition 1406 is detected. This requirement applies regardless of the positioning in time of the start condition 1402 or the repeated start condition 1406. After the repeated start condition 1406 is detected, the benign byte 1408 is received and interpreted as a slave address by the I2C-limited slave devices 304, 306, 308 in accordance with I2C protocols, followed by a stop condition 1410 that is also transmitted on the 2-wire bus 230 in accordance with I2C protocols. The benign byte 1408 and stop condition 1410 can prevent occurrence of a void message by I2C-limited slave devices 304, 306, 308 during I3C modes of operation.

The use of a repeated start condition 1406 causes legacy devices, including the I2C-limited slave devices 304, 306, 308, to reset their bus logic. Resetting the receive logic can clear stuck conditions that may occur at the spike filter 504 (see FIG. 5). For example, a spike filter 504 that is implemented using a resistor-capacitor circuit may produce an SCLI 506 that is stuck at the high logic level when a series of I3C clock pulses has been received. The SCLI 506 may be stuck at the high logic level when the t_{LOW} to t_{HIGH} ratio (see FIG. 4) is insufficiently large to enable the SCLI 506 to return to zero. In such circumstances, a legacy I2C device may enter a middle-of-byte process state. Transmission of a repeated start condition 1406 before transmitting the benign byte 1408 clears the bus logic of the legacy I2C devices and ensures reliable reception of the benign byte 1408.

### Examples of Apparatus and Methods According to Certain Aspects

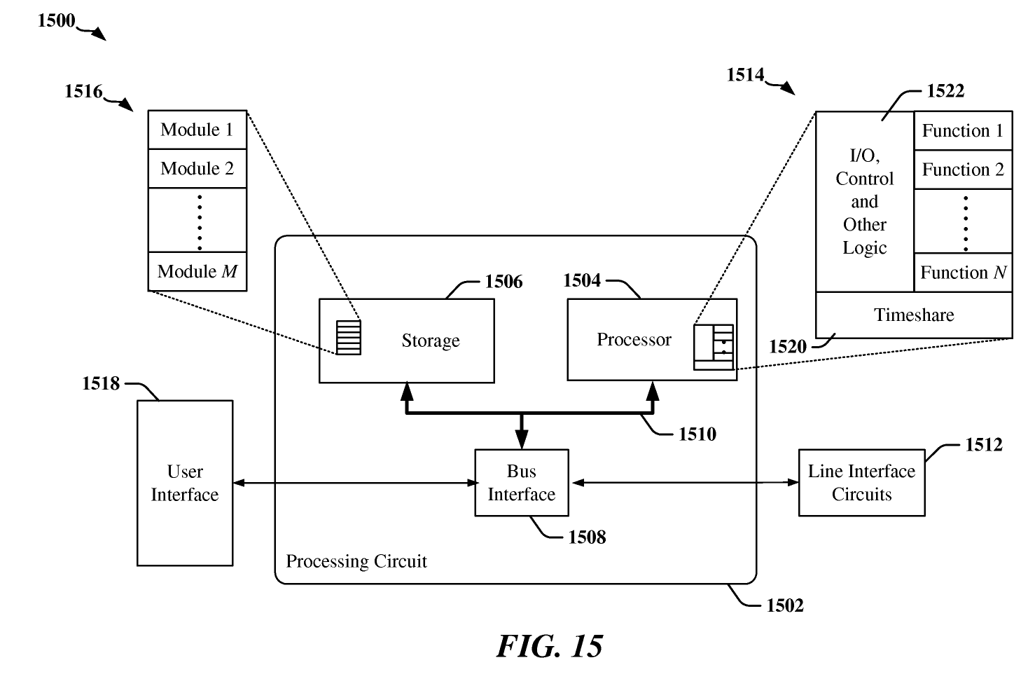

FIG. 15 is a conceptual diagram 1500 illustrating a simplified example of a hardware implementation for an apparatus employing a processing circuit 1502 that may be configured to perform one or more functions disclosed herein. In accordance with various aspects of the disclosure, an element, or any portion of an element, or any combination of elements as disclosed herein may be implemented using the processing circuit 1502. The processing circuit 1502 may include one or more processors 1504 that are controlled by some combination of hardware and software modules. Examples of processors 1504 include microprocessors, microcontrollers, digital signal processors (DSPs), field programmable gate arrays (FPGAs), programmable logic devices (PLDs), application specific integrated circuits (ASICs), state machines, sequencers, gated logic, discrete hardware circuits, and other suitable hardware configured to perform the various functionality described throughout this disclosure. The one or more processors 1504 may include specialized processors that perform specific functions, and that may be configured, augmented or controlled by one of the software modules 1516. The one or more processors 1504 may be configured through a combination of software modules 1516 loaded during initialization, and further configured by loading or unloading one or more software modules 1516 during operation.

In the illustrated example, the processing circuit 1502 may be implemented with a bus architecture, represented generally by the bus 1510. The bus 1510 may include any number of interconnecting buses and bridges depending on the specific application of the processing circuit 1502 and the overall design constraints. The bus 1510 links together various circuits including the one or more processors 1504, and storage 1506. Storage 1506 may include memory devices and mass storage devices, and may be referred to herein as computer-readable media and/or processor-readable media. The bus 1510 may also link various other circuits such as timing sources, timers, peripherals, voltage regulators, and power management circuits. A bus interface 1508 may provide an interface between the bus 1510 and one or more transceivers 1512. A transceiver 1512 may be provided for each networking technology supported by the processing circuit. In some instances, multiple networking technologies may share some or all of the circuitry or processing modules found in a transceiver 1512. Each transceiver 1512 provides a means for communicating with various other apparatus over a transmission medium. Depending upon the nature of the apparatus, a user interface 1518 (e.g., keypad, display, touch interface, speaker, microphone, joystick) may also be provided, and may be communicatively coupled to the bus 1510 directly or through the bus interface 1508.

A processor 1504 may be responsible for managing the bus 1510 and for general processing that may include the execution of software stored in a computer-readable medium that may include the storage 1506. In this respect, the processing circuit 1502, including the processor 1504, may be used to implement any of the methods, functions and techniques disclosed herein. The storage 1506 may be used for storing data that is manipulated by the processor 1504 when executing software, and the software may be configured to implement any one of the methods disclosed herein.

One or more processors 1504 in the processing circuit 1502 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1506 or in an external computer readable medium. The external computer-readable medium and/or storage 1506 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1506 may also include, by way of example, a carrier wave, a transmission line, and any other suitable medium for transmitting software and/or instructions that may be accessed and read by a computer. Computer-readable medium and/or the storage 1506 may reside in the processing circuit 1502, in the processor 1504, external to the processing circuit 1502, or be distributed across multiple entities including the processing circuit 1502. The computer-readable medium and/or storage 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1506 may maintain software maintained and/or organized in loadable code segments, modules, applications, programs, etc., which may be referred to herein as software modules 1516. Each of the software modules 1516 may include instructions and data that, when installed or loaded on the processing circuit 1502 and executed by the one or more processors 1504, contribute to a run-time image 1514 that controls the operation of the one or more processors 1504. When executed, certain instructions may cause the processing circuit 1502 to perform functions in accordance with certain methods, algorithms and processes described herein.

Some of the software modules 1516 may be loaded during initialization of the processing circuit 1502, and these software modules 1516 may configure the processing circuit 1502 to enable performance of the various functions disclosed herein. For example, some software modules 1516 may configure internal devices and/or logic circuits 1522 of the processor 1504, and may manage access to external devices such as the transceiver 1512, the bus interface 1508, the user interface 1518, timers, mathematical coprocessors, and so on. The software modules 1516 may include a control program and/or an operating system that interacts with interrupt handlers and device drivers, and that controls access to various resources provided by the processing circuit 1502. The resources may include memory, processing time, access to the transceiver 1512, the user interface 1518, and so on.

One or more processors 1504 of the processing circuit 1502 may be multifunctional, whereby some of the software modules 1516 are loaded and configured to perform different functions or different instances of the same function. The one or more processors 1504 may additionally be adapted to manage background tasks initiated in response to inputs from the user interface 1518, the transceiver 1512, and device drivers, for example. To support the performance of multiple functions, the one or more processors 1504 may be configured to provide a multitasking environment, whereby each of a plurality of functions is implemented as a set of tasks serviced by the one or more processors 1504 as needed or desired. In one example, the multitasking environment may be implemented using a timesharing program 1520 that passes control of a processor 1504 between different tasks, whereby each task returns control of the one or more processors 1504 to the timesharing program 1520 upon completion of any outstanding operations and/or in response to an input such as an interrupt. When a task has control of the one or more processors 1504, the processing circuit is effectively specialized for the purposes addressed by the function associated with the controlling task. The timesharing program 1520 may include an operating system, a main loop that transfers control on a round-robin basis, a function that allocates control of the one or more processors 1504 in accordance with a prioritization of the functions, and/or an interrupt driven main loop that responds to external events by providing control of the one or more processors 1504 to a handling function.

The processing circuit 1502 may be deployed in various types and examples of electronic devices, including devices that are subcomponents of a mobile apparatus such as a telephone, a mobile computing device, an appliance, automobile electronics, avionics systems, etc. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, or any other similar functioning device.

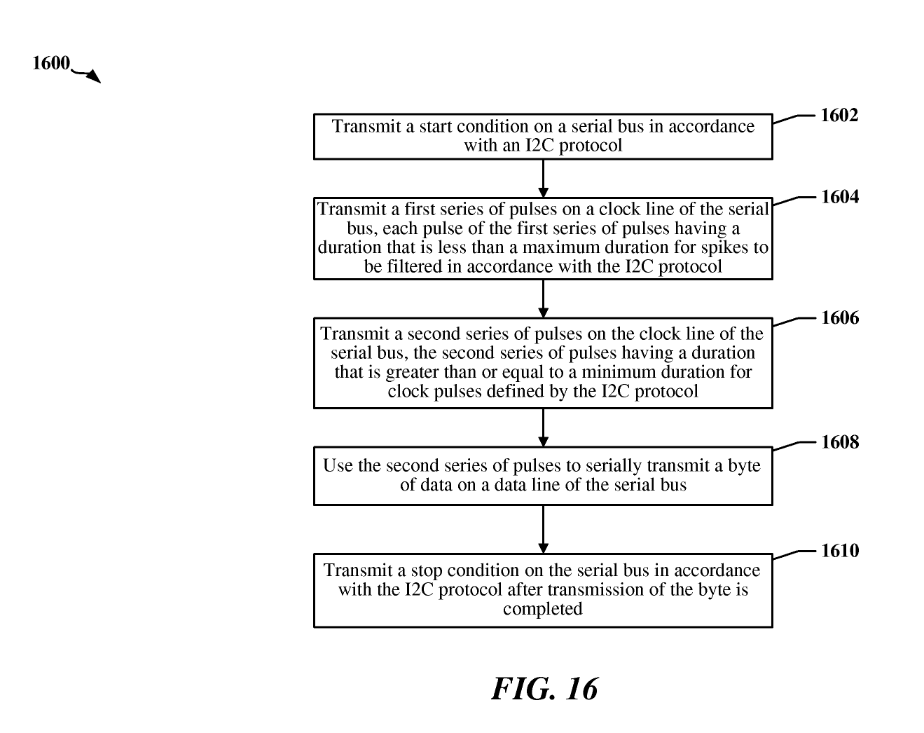

FIG. 16 is a flowchart 1600 illustrating a method for data communications. The method may be performed by a bus master device coupled to a serial bus.

At block 1602, the bus master may transmit a start condition on the serial bus. The start condition may be transmitted in accordance with I2C protocol. In one example, the start condition may correspond to the start condition 622 in FIG. 6.

At block 1604, the bus master may transmit a first series of pulses on a clock line of the serial bus. The clock line may be the SCL 216 of FIG. 2, for example. Each pulse in the first series of pulses may have a duration that is less than a maximum duration for spikes to be filtered in accordance with the I2C protocol.

At block 1606, the bus master may transmit on the clock line of the serial bus after the first series of pulses, a second series of pulses having a duration that is greater than or equal to a minimum duration for clock pulses defined by the I2C protocol.

At block 1608, the bus master may use the second series of pulses to serially transmit a byte of data on a data line of the serial bus.

At block 1610, the bus master may transmit a stop condition on the serial bus. The start condition may be transmitted after transmission of the byte is completed, and in accordance with I2C protocol. In one example, the start condition may correspond to the stop condition 624 in FIG. 6.

In some examples, the bus master may transmit a repetition of the start condition on the serial bus in accordance with the I2C protocol, and prior to transmission of the byte and prior to transmission of the stop condition. In one example, the repetition of the start condition may correspond to the repeated start condition 828 illustrated in FIG. 8. The repeated start condition 828 may be transmitted after transmission of the first series of pulses has been completed.

According to certain aspects, the first series of pulses may be used to control communication of data on the data line of the serial bus. The data communicated using the first series of pulses may be transmitted in accordance with an I3C protocol.

In one example, each pulse in the first series of pulses has a duration of 50 nanoseconds or less, and each pulse in the second series of pulses has a duration that is greater than 50 nanoseconds.

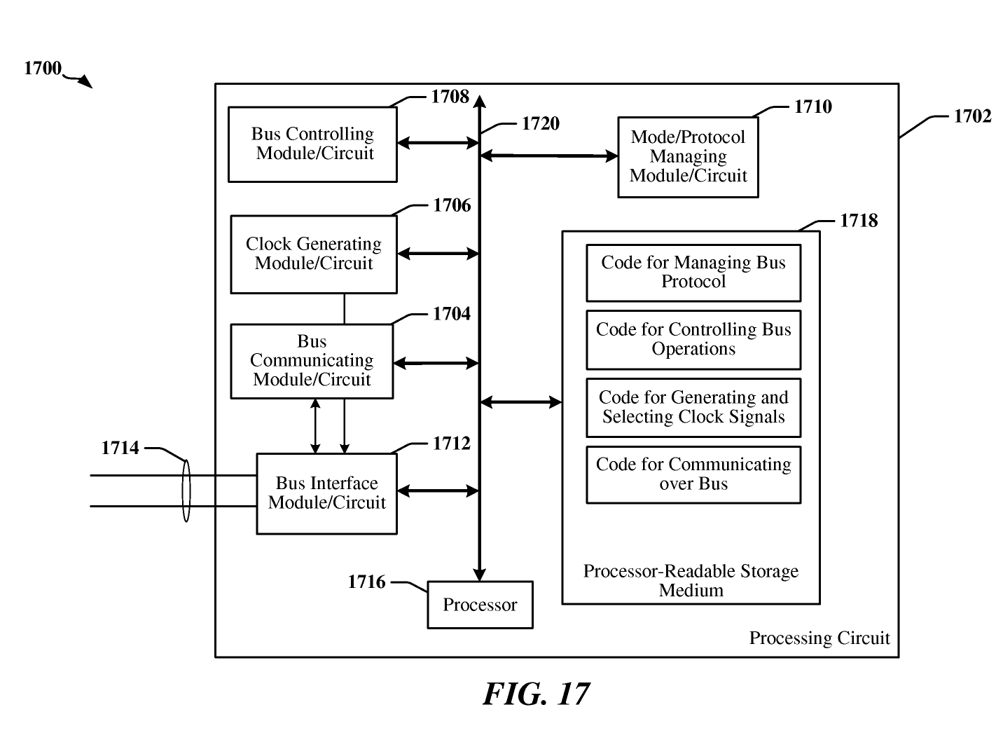

FIG. 17 is a diagram illustrating an example of a hardware implementation for an apparatus 1700 employing a processing circuit 1702. The processing circuit typically has a processor 1716 that may include a microprocessor, microcontroller, digital signal processor, an ASIC, a sequencer or a state machine. The processing circuit 1702 may be implemented with a bus architecture, represented generally by the bus 1720. The bus 1720 may include any number of interconnecting buses and bridges depending on the specific application of the processing circuit 1702 and the overall design constraints. The bus 1720 links together various circuits including one or more processors and/or hardware modules, represented by the processor 1716, the modules or circuits 1704, 1706, 1708, and 1710, a bus interface 1712 operable to couple the apparatus 1700 to a serial bus 1714, and the computer-readable storage medium 1718. The bus 1720 may also link various other circuits such as timing sources, peripherals, voltage regulators, and power management circuits, which are well known in the art.

The processor 1716 is responsible for general processing, including the execution of software stored on the computer-readable storage medium 1718. The software, when executed by the processor 1716, causes the processing circuit 1702 to perform the various functions described supra for any particular apparatus. The computer-readable storage medium 1718 may also be used for storing data that is manipulated by the processor 1716 when executing software, including data communicated through the serial bus 1714. The processing circuit 1702 further includes at least one of the modules 1704, 1706, 1708, and 1710. The modules 1704, 1706, 1708, and 1710 may be software modules running in the processor 1716, resident/stored in the computer-readable storage medium 1718, one or more hardware modules coupled to the processor 1716, or some combination thereof. The modules 1704, 1706, 1708, and/or 1710 may include microcontroller instructions, state machine configuration parameters, or some combination thereof.

In one configuration, the apparatus 1700 may be adapted for use as a bus master coupled to the serial bus 1714. The apparatus 1700 may include buffer interface modules and/or circuits 1712 such as a transceiver configured to exchange data through a data line of the serial bus 1714 and a line driver configured to control signaling state of a clock line of the serial bus 1714. The apparatus 1700 may include bus communicating modules and/or circuits 1704, including a transmitter circuit coupled to the transceiver and the line driver. The apparatus 1700 may include bus control modules and/or circuits 1708 configured to generate start conditions, stop conditions and repeated start conditions on the serial bus 1714 in accordance with the I2C protocol. The apparatus 1700 may include mode and protocol management modules and/or circuits 1710 and clock generating modules and/or circuits.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of data communications at a bus master device coupled to a serial bus, comprising:
transmitting a start condition on the serial bus in accordance with an Inter-Integrated Circuit (I2C) protocol;
transmitting a first series of pulses on a clock line of the serial bus, each pulse of the first series of pulses having a duration that is less than a maximum duration for spikes to be filtered in accordance with the I2C protocol;
transmitting a second series of pulses on the clock line of the serial bus, the second series of pulses having a duration that is greater than or equal to a minimum duration for clock pulses defined by the I2C protocol;
using the second series of pulses to serially transmit a byte of data on a data line of the serial bus; and
transmitting a stop condition on the serial bus in accordance with the I2C protocol after transmission of the byte of data is completed.

2. The method of claim 1, further comprising:
transmitting a second start condition on the serial bus in accordance with the I2C protocol before transmission of the byte of data and before transmission of the stop condition.

3. The method of claim 2, wherein the second start condition is transmitted after transmission of the first series of pulses has been completed.

4. The method of claim 1, wherein the second series of pulses is interleaved with the first series of pulses.

5. The method of claim 1, wherein a slave device coupled to the serial bus has a spike filter that is configured to block the first series of pulses and pass the second series of pulses.

6. The method of claim 1, further comprising:
using the first series of pulses to control communication of data on the data line of the serial bus.

7. The method of claim 1, wherein the data communicated using the first series of pulses is transmitted in accordance with an I3C protocol.

8. The method of claim 1, wherein each pulse in the first series of pulses has a duration of 50 nanoseconds or less.

9. The method of claim 1, wherein each pulse in the second series of pulses has a duration that is greater than 50 nanoseconds.

10. The method of claim 1, wherein the byte of data includes a slave address.

11. A bus master apparatus configured to be coupled to a serial bus, comprising:
a transceiver configured to exchange data through a data line of the serial bus;
a line driver configured to control signaling state of a clock line of the serial bus; and
a transmitter circuit coupled to the transceiver and the line driver and configured to:
transmit a start condition on the serial bus in accordance with an Inter-Integrated Circuit (I2C) protocol;
transmit a first series of pulses on a clock line of the serial bus, each pulse of the first series of pulses having a duration that is less than 50 nanoseconds;
use the first series of pulses to serially transmit a first byte of data on a data line of the serial bus;
transmit a second series of pulses on the clock line of the serial bus, the second series of pulses having a duration that is greater than or equal to 50 nanoseconds;
use the second series of pulses to serially transmit a second byte of data on the data line of the serial bus; and
transmit a stop condition on the serial bus in accordance with the I2C protocol after transmission of the second byte of data is completed.

12. The bus master of claim 11, wherein the transmitter circuit is configured to:
transmit on the serial bus, a repetition of the start condition in accordance with the I2C protocol prior to transmission of the second byte of data and prior to transmission of the stop condition.

13. The bus master of claim 12, wherein the repetition of the start condition is transmitted after transmission of the first series of pulses has been completed.

14. The bus master of claim 11, wherein the transmitter circuit is configured to:
interleave the second series of pulses with the first series of pulses.

15. The bus master of claim 11, wherein the first byte of data is transmitted to a first slave device configured to sample the first byte of data using the first series of pulses.

16. The bus master of claim 15, wherein the second byte of data is transmitted to a second slave device configured to sample the second byte of data using the second series of pulses.

17. The bus master of claim 15, wherein the first slave device is further configured to sample the second byte of data using the second series of pulses.

18. An apparatus comprising:
a first device coupled to a serial bus;
a second device coupled to the serial bus, and comprising a transmitter circuit configured to:
use the serial bus to transmit a start condition to the first device in accordance with an Inter-Integrated Circuit (I2C) protocol;
transmit a first series of pulses on a clock line of the serial bus, each pulse of the first series of pulses having a duration that is less than 50 nanoseconds;
use the first series of pulses to serially transmit a first byte of data on a data line of the serial bus;
transmit a second series of pulses on the clock line of the serial bus, the second series of pulses having a duration that is greater than or equal to 50 nanoseconds;
use the second series of pulses to control transmission of a second byte of data through a data line of the serial bus; and
use the serial bus to transmit a stop condition to the first device in accordance with the I2C protocol after transmission of the second byte of data is completed.

19. The apparatus of claim 18, wherein the transmitter circuit is configured to:
transmit to the first device using the serial bus, a repetition of the start condition in accordance with the I2C protocol prior to transmission of the second byte of data and prior to transmission of the stop condition.

20. The apparatus of claim 19, wherein the repetition of the start condition is transmitted after transmission of the first series of pulses has been completed.

21. The apparatus of claim 18, wherein the transmitter circuit is configured to: interleave the second series of pulses with the first series of pulses.

22. The apparatus of claim 18, and further comprising:
a third device coupled to the serial bus, and configured to sample the first byte of data using the first series of pulses.

23. The apparatus of claim 22, wherein the first device is configured to sample the second byte of data using the second series of pulses.

24. The apparatus of claim 18, wherein the first device is configured to sample the first byte of data using the second series of pulses.

25. The apparatus of claim 18, wherein the first device includes a spike filter that is configured to block pulses received from the serial bus with a duration that is less than 50 nanoseconds.

26. The apparatus of claim 18, wherein the first device and the second device are integrated circuit devices.

27. A processor readable storage medium having code executable by the processor stored thereon, the code comprising instructions for:
transmitting a start condition on a serial bus in accordance with an Inter-Integrated Circuit (I2C) protocol;
transmitting a first series of pulses on a clock line of the serial bus, each pulse of the first series of pulses having a duration that is less than a maximum duration for spikes to be filtered in accordance with the I2C protocol;
transmitting a second series of pulses on the clock line of the serial bus, the second series of pulses having a duration that is greater than or equal to a minimum duration for clock pulses defined by the I2C protocol;
using the second series of pulses to serially transmit a byte of data on a data line of the serial bus; and
transmitting on the serial bus, a stop condition in accordance with the I2C protocol after transmission of the byte of data is completed.

28. The storage medium of claim 27, further comprising:
transmitting a second start condition on the serial bus in accordance with the I2C protocol before transmission of the byte of data and before transmission of the stop condition, wherein the second start condition is transmitted after transmission of the first series of pulses has been completed.

29. The storage medium of claim 27, wherein each pulse in the first series of pulses has a duration of 50 nanoseconds or less and each pulse in the second series of pulses has a duration that is greater than 50 nanoseconds.

30. The storage medium of claim 27, wherein the code comprises instructions for:
using the first series of pulses to exchange first data with a first device in accordance with an I3C protocol; and
using the second series of pulses to exchange second data with a second device in accordance with the I2C protocol.
